(19) United States
(12) Patent Application Publication
(10) Pub. No.: US 2010/0224023 A1
(43) Pub. Date: Sep. 9, 2010

(54) SUPPORT ARM AND INDUSTRIAL ROBOT USING THE SAME

(75) Inventors: BO LONG, Shenzhen City (CN); XIAO-MING XU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/538,159

(22) Filed: Aug. 9, 2009

(30) Foreign Application Priority Data
Mar. 7, 2009 (CN) 200910300734.0

(51) Int. Cl. B25J 17/00

(52) U.S. Cl. 74/490.05

(57) ABSTRACT

A support arm used in an industrial robot includes a first joint portion, a second joint portion, and a connecting portion between the first and second joint portions. The connecting portion includes a plurality of connecting walls. The plurality of connecting walls and the first and second joint portions cooperatively define a cavity. One of the connecting walls defines an opening communicating with the cavity and forms a plurality of reinforced ribs extending from the periphery of the opening towards the cavity of the support arm.

### BACKGROUND

1. Technical Field

The present disclosure generally relates to robotic limbs, and particularly to a support arm for an industrial robot.

2. Description of Related Art

FIG. 9 is a schematic view showing a commonly employed industrial robot. The industrial robot includes a base seat 11, a joint portion 12 rotatably connected to the base seat 11, a lower support arm 13 rotatably connected to the joint portion 12, and an upper support arm 14 rotatably connected to the lower support arm 13. The joint portion 12 is rotatable around a first axis a. The lower support arm 13 is rotatable around a second axis b. The upper support arm 14 is rotatable around a third axis c. The industrial robot also includes fourth, fifth and sixth axes of rotation schematically indicated by d, e and f, respectively. An operating device, such as a clamp, a cutter or a detector is generally positioned on the upper support arm 14 along the sixth axis f to realize various operations.

The upper support arm 14 requires sufficient stiffness to resist complicated forces applied thereon, while maintaining a light weight to increase flexibility of operation. Generally, the upper arm 14 is a hollow structure to achieve such stiffness and weight requirements. However, it is difficult to manufacture the hollow upper support arm 14, because the cavity defined in the upper arm 14 is closed and difficult to position accurately. Thus, the wall thickness of the upper support arm 14 may be nonuniform, with stress distributed on the upper support arm 14 correspondingly nonuniform. As a result, vibration of the upper support arm 14 may occur during operation, with operating accuracy of the industrial robot reduced accordingly.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an isometric view of one embodiment of a support arm for an industrial robot.

FIG. 2 is similar to FIG. 1, but viewed from another aspect.

FIG. 3 is an isometric longitudinal cross section of the support arm in FIG. 1.

FIG. 4 is an isometric lateral cross section of the support arm of FIG. 1.

FIGS. 5 and 6 are numerical simulation stress distribution views of the support arm in FIG. 1.

FIGS. 7 and 8 are first-order vibration frequency and second-order vibration frequency views of the support arm in FIG. 1.

FIG. 9 is a flat view of a typical industrial robot of a related art.

### DETAILED DESCRIPTION

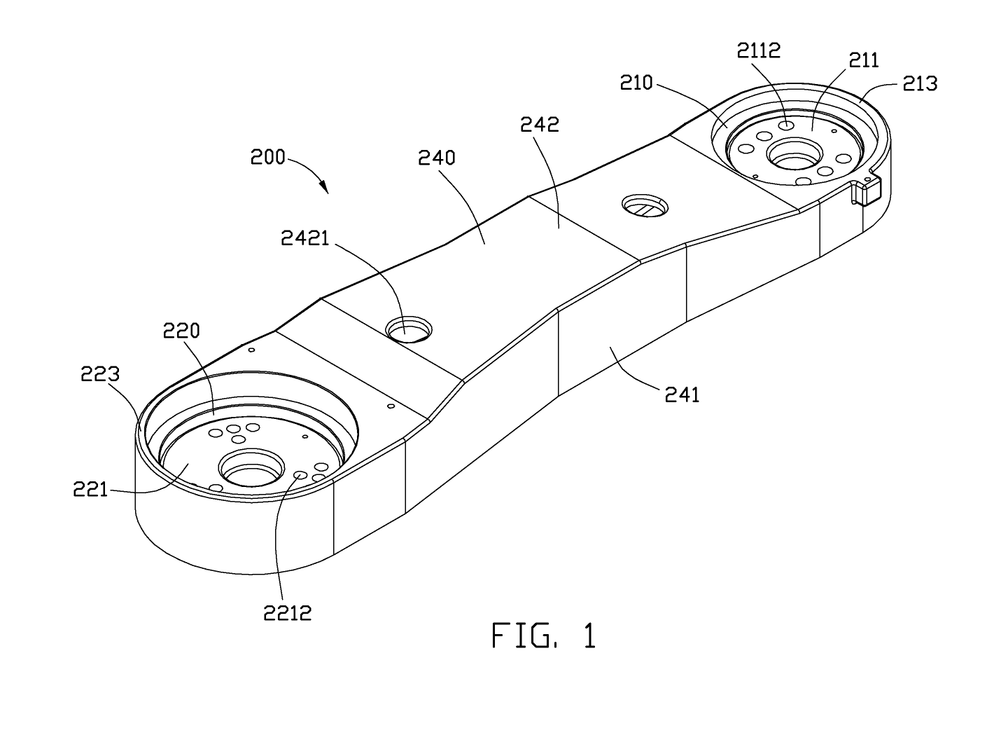

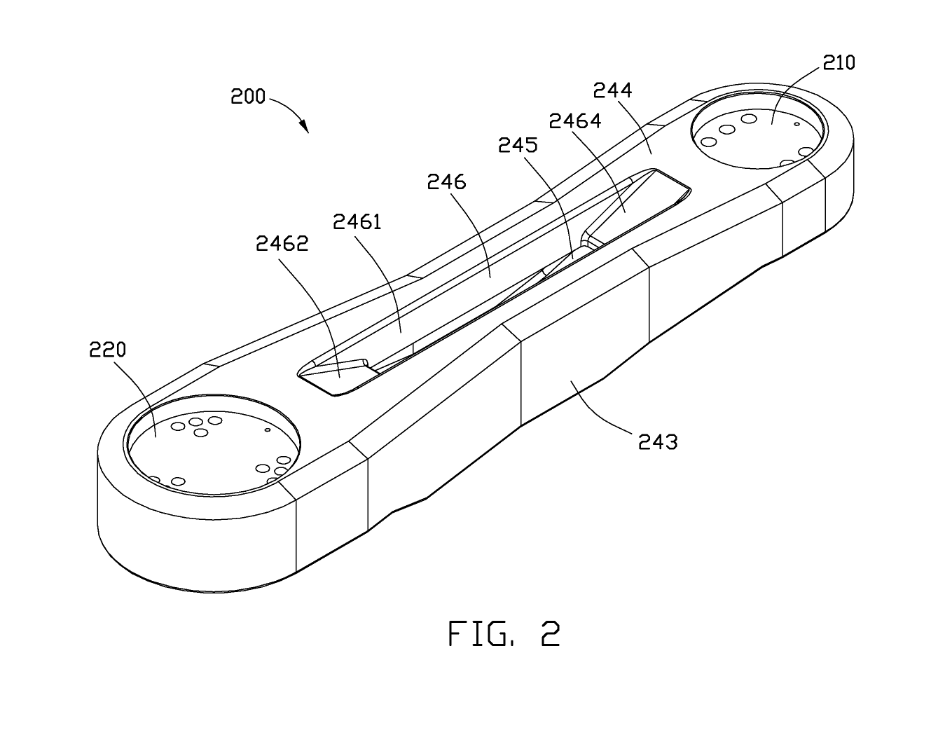

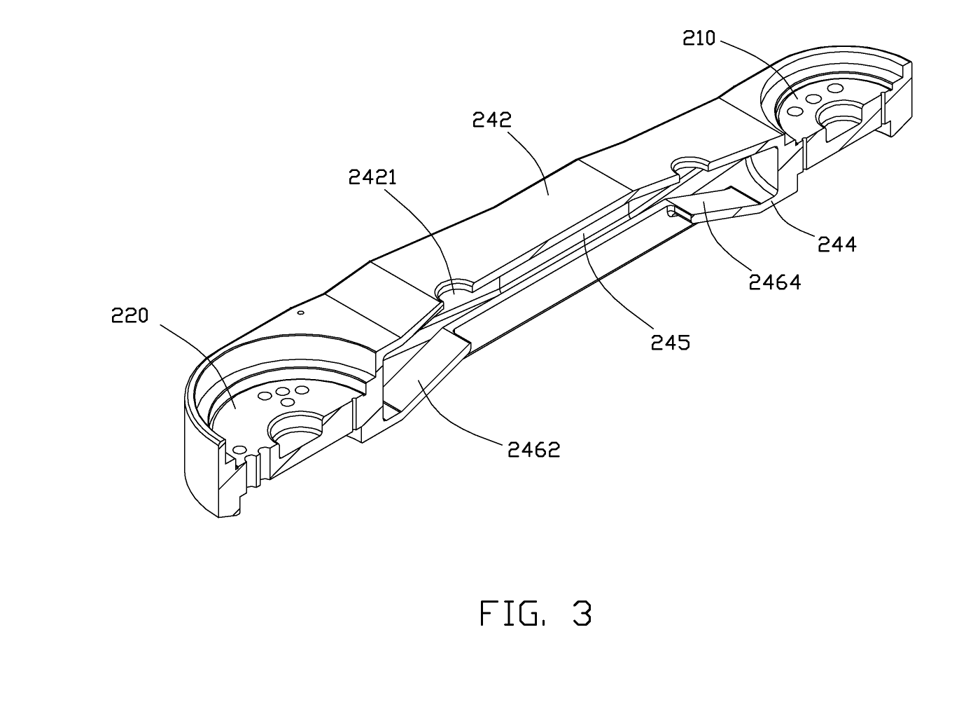

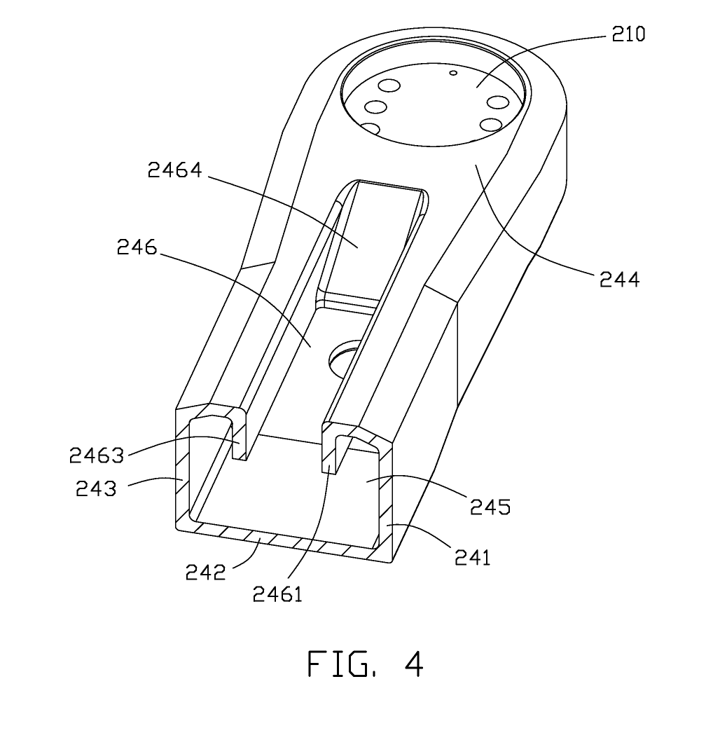

Referring to FIGS. 1 through 4, one embodiment of a support arm 200 for an industrial robot includes a first joint portion 210, a second joint portion 220, and a connecting portion 240 between the first and second joint portions 210, 220. The connecting portion 240 includes four connecting walls 241, 242, 243, and 244 connected one by one. The four connecting walls 241, 242, 243, 244, and the first and second joint portions 210, 220 cooperatively define a cavity 245.

The first joint portion 210 includes a main body 211 and a reinforced wall 213 formed around the main body 211. In the illustrated embodiment, the main body 211 is substantially cylindrical. The main body 211 defines a plurality of mounting holes 2112 to connect a first gear (not shown). The first gear may be used to drive an operating device, such as a clamp, a cutter or a detector connected to the support arm 200, to operate.

The second joint portion 220 is similar in structure to the first joint portion 210, and also includes a main body 221 and a reinforced wall 223 formed around the main body 221. The main body 221 defines a plurality of mounting holes 2212 to connect a second gear (not shown) to drive the support arm 200 to operate.

In the illustrated embodiment, the diameter of the main body 221 is larger than that of the main body 211. The thickness of the reinforced wall 223 is larger than that of the reinforced wall 213. Thus, the support arm 200 works like a cantilever beam structure, and the second joint portion 220, as a supporting end, can bear more torque.

The connecting walls 241, 243 are symmetrically positioned on opposite sides of the support arm 200, and smoothly connected to the first and second joint portions 210, 220. In the illustrated embodiment, the middle portions of the connecting walls 241, 243 are recessed inwards to meet aesthetic requirements.

The connecting wall 242 connects first ends of the connecting walls 241, 243, and defines two through holes 2421 in the connecting wall 242.

The connecting wall 244 connects second ends of the connecting walls 241, 243, and defines an opening 246 communicating with the cavity 245. Four reinforced ribs 2461, 2462, 2463, 2464 extend from the periphery of the opening 246 towards the cavity 245 of the support arm 200. The reinforced ribs 2461, 2462, 2463, 2464 are connected one by one. In the illustrated embodiment, the opening 246 is substantially rectangular and elongated along the extending axis of the support arm 200. The reinforced ribs 2461, 2463 respectively adjacent to the connecting walls 241, 243 extend substantially perpendicularly from the opposite sides of the opening 246. The reinforced ribs 2464, 2462 respectively adjacent to the first and second joint portions 210, 220 are slanted towards the center of the support arm 200. The slanted reinforced ribs 2462, 2464 are longer than they are vertical, thus facilitating increased stiffness of the support arm 200.

In the illustrated embodiment, the edges defined by the connecting wall 244 and the connecting walls 241, 243 are flattened to prevent stress concentration. Alternatively, other edges of the support arm 200 may all be flattened. The support arm 200 may be manufactured by light materials having high-strength, such as cast aluminum or aluminum alloy.

Because the cavity 245 is not closed and can be accurately defined in the support arm 200 during the manufacturing process, the wall thickness of the support arm 200 is substantially uniform, the stress distributed on the support arm 200 is substantially uniform accordingly, thereby decreasing vibration during operation. In addition, when the support arm 200 is used in an industrial robot, electric wires of a gear or an operating device may be received in the opening 246 to save occupying space.

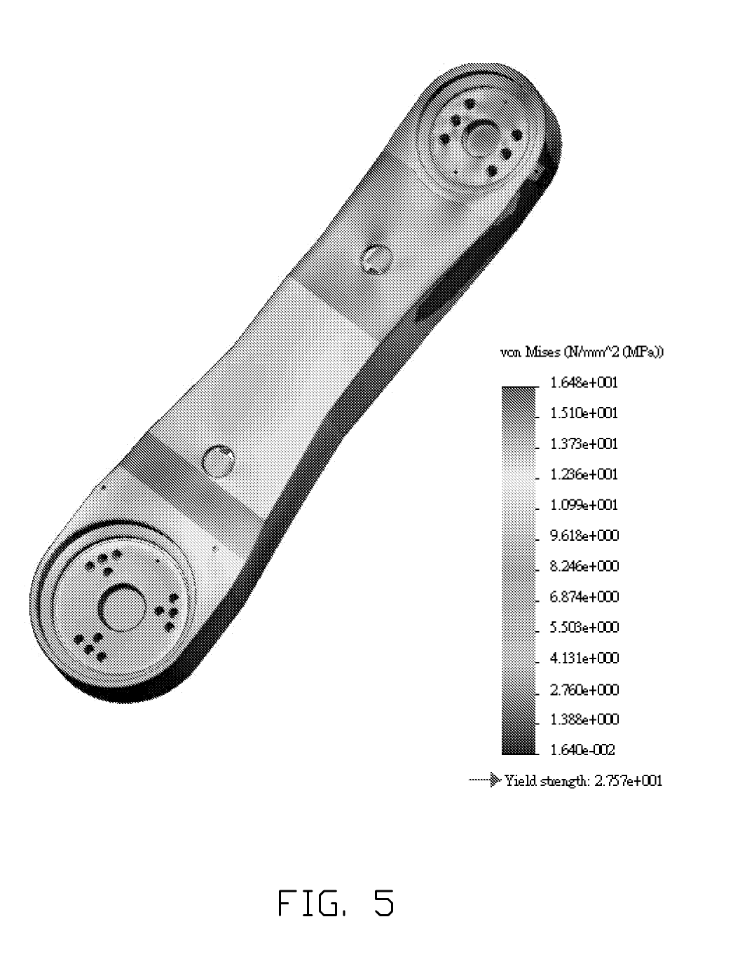

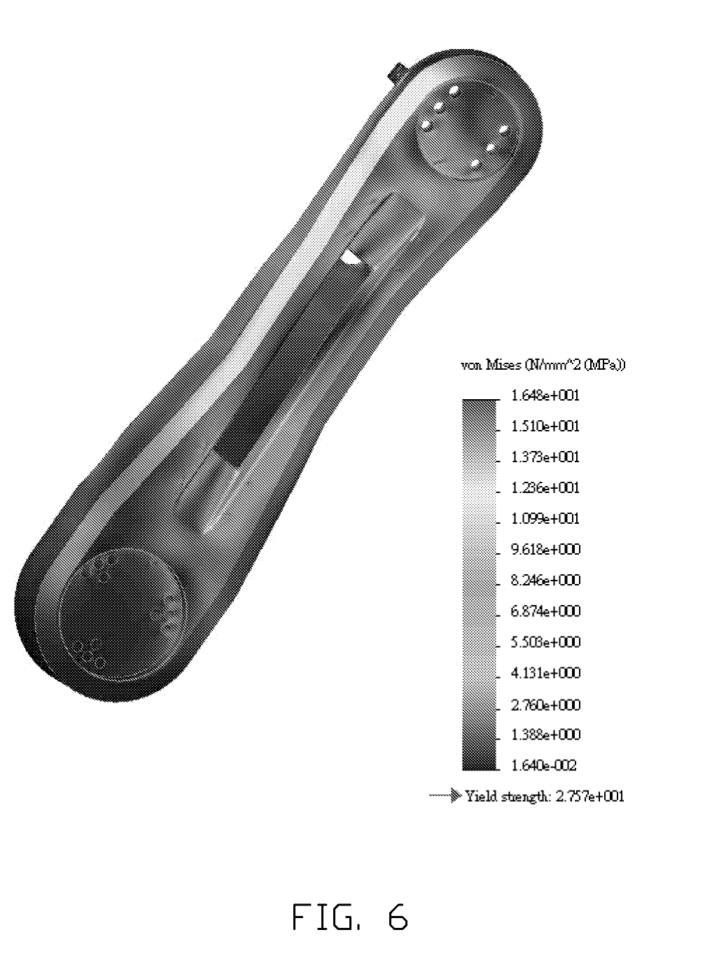

FIGS. 5 and 6 show the numerical simulation stress distribution of the support arm 200. The data was obtained via finite element analysis using ANSYS software, and show that the stress is substantially evenly distributed on the support arm 200, so that the support arm 200 has a high stiffness and good mechanical properties. Initial performance parameters of the support arm 200 used for numerical simulation are shown in Table 1.

TABLE 1

| Parameter | Value | Unit |
|---|---|---|
| Elastic modulus | 6.9E+10 | N/m² |
| Poisson ratio | 0.33 | — |
| Shear modulus | 2.7E+10 | N/m² |
| Mass density | 2700 | Kg/m³ |
| Tensile strength | 68935600 | N/m² |
| Yield strength | 27574200 | N/m² |
| Thermal expansion coefficient | 2.4E−5 | 1/Kelvin |
| Thermal conductivity | 200 | W/(m · K) |
| Specific heat | 900 | J/(kg · K) |

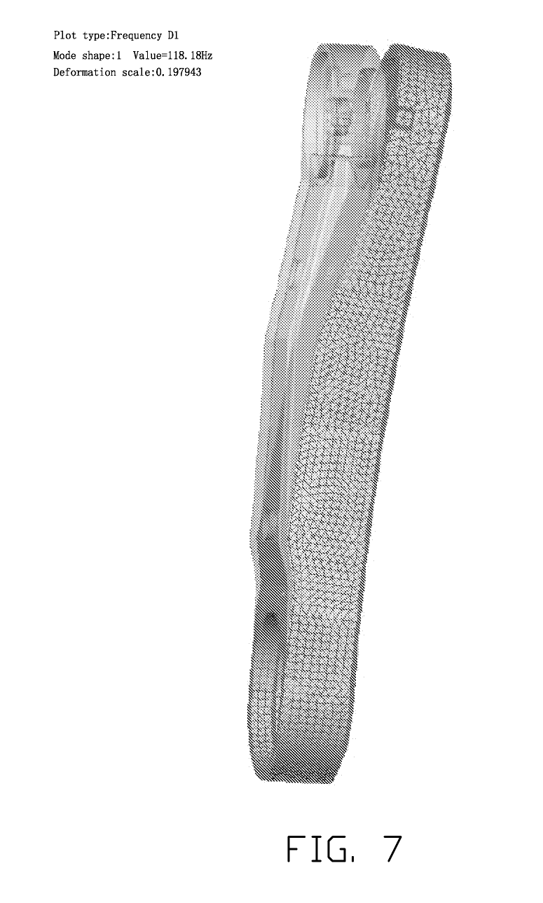

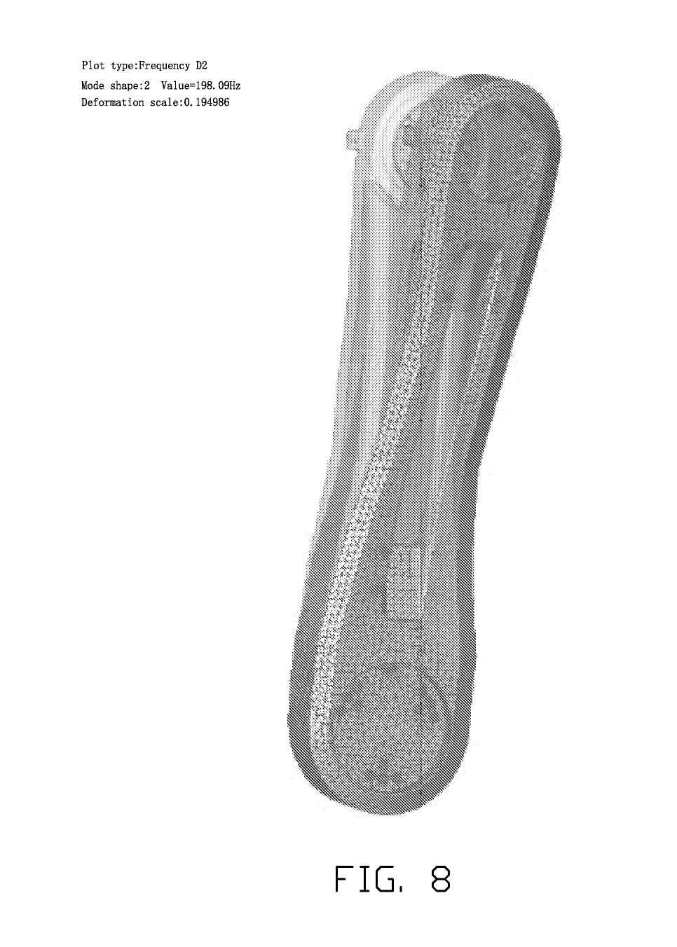

FIGS. 7 and 8 respectively show the first-order and second-order vibration frequency views of the support arm 200, and the first-order to fifth-order vibration frequency values of the support arm 200 are shown in Table 2. The data was obtained via finite element analysis using ANSYS software, and show that the first-order and second-order vibration frequencies of the support arm 200 are low, such that support arm 200 can operate at high speeds without inducing resonance.

TABLE 2

| Mode | Frequency | Frequency | Cycle |
|---|---|---|---|
| number | (radians/sec) | (Hz) | (seconds) |
| 1 | 738.87 | 118.18 | 0.008504 |
| 2 | 1238.3 | 198.09 | 0.005074 |
| 3 | 3433.7 | 546.49 | 0.00183 |
| 4 | 3844.8 | 611.92 | 0.001634 |
| 5 | 5677.8 | 903.66 | 0.001107 |

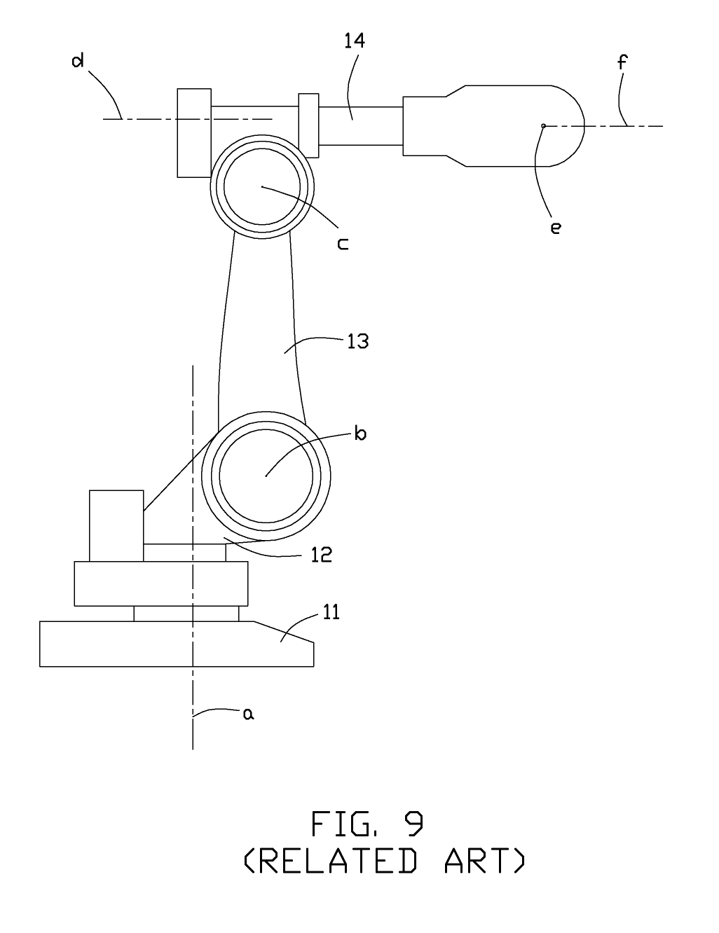

The support arm 200 may be used in a six-axis robot. The six-axis robot is similar in principle to the typical industrial robot shown in FIG. 9, differing only in that the six-axis robot using the support arm 200 as an upper support arm. Because the support arm 200 has light weight and high stiffness, it is compatible with low-cost and conveniently compact driving motors, so that the cost and the weight of the six-axis robot may be decreased. During operation, stress distributed on the support arm 200 is uniform, with vibration frequency of the support arm 200 low, so that overall operating accuracy of the six-axis robot is improved.

It should be understood that the support arm 200, the first and second joint portions 210, 220, and the cavity 245 of the support arm 200 may be other shapes. The support arm 200 may be used in other type robots, such as linear coordinate robots, cylindrical coordinate robots, spherical coordinate robots, or other multi-axis robots.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A support arm used in an industrial robot, comprising:
a first joint portion;
a second joint portion; and
a connecting portion between the first and second joint portions, and comprising a plurality of connecting walls, the plurality of connecting walls and the first and second joint portions cooperatively defining a cavity, wherein one of the connecting walls defines an opening communicating with the cavity and forms a plurality of reinforced ribs extending from the periphery of the opening towards the cavity of the support arm.

2. The support arm of claim 1, wherein each of the first and second joint portions comprises a main body and a reinforced wall formed around the main body.

3. The support arm of claim 2, wherein the main body of each of the first and second joint portions is substantially cylindrical and the diameter of the main body of the second joint portion is larger than that of the main body of the first joint portion.

4. The support arm of claim 2, wherein the reinforced wall of the second joint portion is thicker than the reinforced wall of the first joint portion.

5. The support arm of claim 1, wherein the other connecting wall of the connecting portion defines two through holes.

6. The support arm of claim 1, wherein the opening is substantially rectangular and elongated along the extending axis of the support arm; and four reinforced ribs extend from the periphery of the opening towards the cavity of the support arm, the four reinforced ribs are connected one by one.

7. The support arm of claim 6, wherein two reinforced ribs respectively adjacent to the opposite connecting walls extend substantially perpendicularly from the opposite sides of the opening.

8. The support arm of claim 6, wherein two reinforced ribs respectively adjacent to the first and second joint portions are slanted towards the center of the support arm.

9. The support arm of claim 1, wherein the plurality of connecting walls of the connecting portion are connected one by one, and smoothly connected to the first and second joint portions.

10. The support arm of claim 1, wherein edges defined by adjacent connecting walls are flattened.

11. The support arm of claim 1, wherein the support arm is manufactured by cast aluminum or aluminum alloy.

12. An industrial robot comprising:
a support arm to connect an operating device, the support arm comprising:
a first joint portion;
a second joint portion; and
a connecting portion between the first and second joint portions and the connecting portion comprising a plurality of connecting walls, the plurality of connecting walls and the first and second joint portions cooperatively defining a cavity, wherein one of the connecting walls defines an opening communicating with the cavity and forms a plurality of reinforced ribs extending from the periphery of the opening towards the cavity of the support arm.

13. The industrial robot of claim 12, wherein each of the first and second joint portions comprises a main body and a reinforced wall formed around the main body.

14. The industrial robot of claim 13, wherein the main body of each of the first and second joint portions is substantially cylindrical; the diameter of the main body of the second joint portion exceeding that of the main body of the first joint portion.

15. The industrial robot of claim 13, wherein the reinforced wall of the second joint portion is thicker than the reinforced wall of the first joint portion.

16. The industrial robot of claim 12, wherein the other connecting wall of the connecting portion defines two through holes.

17. The industrial robot of claim 12, wherein the opening is substantially rectangular and elongated along the extending axis of the support arm; and four reinforced ribs extend from the periphery of the opening towards the cavity of the support arm, the four reinforced ribs are connected one by one.

18. The industrial robot of claim 17, wherein two reinforced ribs respectively adjacent to the opposite connecting walls extend substantially perpendicularly from the opposite sides of the opening.

19. The industrial robot of claim 17, wherein two reinforced ribs respectively adjacent to the first and second joint portions are slanted towards the center of the support arm.
